(19) United States
(12) Patent Application Publication
(10) Pub. No.: US 2023/0399529 A1
(43) Pub. Date: Dec. 14, 2023

(54) CARBON FIBER BLENDED MODIFIED 3D PRINTING CONSUMABLES AND METHOD FOR MANUFACTURING CARBON FIBER BLENDED MODIFIED 3D PRINTING CONSUMABLES

(71) Applicant: DEQUN PAN, FOSHAN (CN)

(72) Inventor: DEQUN PAN, FOSHAN (CN)

(21) Appl. No.: 17/806,604

(22) Filed: Jun. 13, 2022

(51) Int. Cl. C09D 7/40; B33Y 70/10; C09D 7/61; C09D 169/00; C09D 167/02; C09D 167/04; C09D 177/00

(52) U.S. Cl. CPC C09D 7/70; B33Y 70/10; C09D 7/61; C09D 169/00; C09D 167/02; C09D 167/04; C09D 177/00

(57) ABSTRACT

Carbon fiber blended modified 3D printing consumables include one of carbon fiber polycarbonate 3D printing consumables, carbon fiber polylactic acid 3D printing consumables, carbon fiber copolyester 3D printing consumables, carbon fiber copolymer 3D printing consumables, and carbon fiber nylon 3D printing consumables. A method for manufacturing carbon fiber blended modified 3D printing consumables includes steps of proportioning raw materials required for manufacturing 3D printing consumables, putting proportioned raw materials into a high-speed mixer to mix to obtain a mixture, putting the mixture of the proportioned raw materials and carbon fibers into a twin-screw modified granulator for modification; obtaining plastic wire and cutting the obtained plastic wire into pellets; cooling and drying the pellets, putting dried pellets into a single-screw wire-drawing device to obtain manufactured 3D printing consumables; cooling the manufactured 3D printing consumables, and rewinding the manufactured 3D printing consumables by a winding device.

### TECHNICAL FIELD

The present disclosure relates to plastic modifications of 3D printing consumables and further relates to manufacturing the 3D printing consumables, in particular to carbon fiber blended modified 3D printing consumables and a manufacturing method thereof.

### BACKGROUND

3D printer technology, also known as additive manufacturing, is a technology that constructs objects by layer-by-layer printing based on digital model files and using bondable materials such as powdered metal or plastic. 3D printing is usually performed by digital technology material printers. It is generally used to make models in fields of mold manufacturing, industrial design, etc., and is gradually used for direct manufacturing of some products. There are already pieces printed by the 3D printing technology in jewelry, footwear, industrial design, architecture, engineering and construction, automotive, aerospace, dental and medical industries, education, geographic information systems, civil engineering, firearms, and other fields.

In a process of 3D printing, 3D printing consumables are used to complete 3D printing. Common raw materials used in 3D printing comprise PLA, ABS, photosensitive resin, wax-based materials, nylon powder, gypsum-like powder, metal powder, etc. These raw materials are used as basic materials and other auxiliary materials are added, and then they are processed by a processing equipment to obtain 3D printing consumables.

At present, there are not many varieties of plastic consumables for 3D printing, and mainly used plastic consumables are PLA and ABS. Most of other high-performance engineering plastics cannot be used in 3D printing equipment. Further, physical properties of materials such as PLA, which are widely used in 3D printing, are not satisfied and cannot be used in the applications requiring high mechanical strength. Moreover, ordinary modified engineering plastics are not suitable for direct production of the 3D printing consumables, so the present disclosure proposes a method for manufacturing carbon fiber blended modified 3D printing consumables to overcome shortages existing in the prior art.

### SUMMARY

In view of above problems, a purpose of the present disclosure is to provide a method for manufacturing carbon fiber blended modified 3D printing consumables to solve problems that there are not many varieties of plastic consumables for 3D printing and mainly used plastic consumables are PLA and ABS, most of other high-performance engineering plastics cannot be used in 3D printing equipment. Further, the present disclosure solves problems that physical properties of materials such as PLA, which are widely used in 3D printing, are not satisfied and cannot be used in the applications requiring high mechanical strength; and ordinary modified engineering plastics are not suitable for direct producing of the 3D printing consumables.

In order to realize the purpose of the present disclosure, the present disclosure is embodied through the following technical solutions.

The present disclosure provides carbon fiber blended modified 3D printing consumables. The carbon fiber blended modified 3D printing consumables comprise one of carbon fiber polycarbonate 3D printing consumables, carbon fiber polylactic acid 3D printing consumables, carbon fiber copolyester 3D printing consumables, carbon fiber copolymer 3D printing consumables, carbon fiber nylon 3D printing consumables, and other carbon fiber plastic 3D printing consumables.

The carbon fiber polycarbonate 3D printing consumables comprise polycarbonate in a range of 20-60% by weight, copolyester in a range of 20-60% by weight, phase solvent in a range of 1-5% by weight, antioxidant in a range of 0.3-1% by weight, and carbon fiber material in a range of 3-15% by weight.

The carbon fiber polylactic acid 3D printing consumables comprise polylactic acid in a range of 40-80% by weight, toughening agent in a range of 5-15% by weight, the phase solvent in a range of 1-5% by weight, the antioxidant in a range of 0.3-1% by weight, and the carbon fiber material in a range of 3-15% by weight.

The carbon fiber copolyester 3D printing consumables comprise the copolyester in a range of 40-80% by weight, the toughening agent in the range of 5-15% by weight, the phase solvent in the range of 1-5% by weight, the antioxidant in the range of 0.3-1% by weight, and the carbon fiber material in the range of 3-15% by weight.

The carbon fiber nylon 3D printing consumables comprise nylon in a range of 40-80% by weight, the toughening agent in the range of 5-15% by weight, the phase solvent in the range of 1-5% by weight, the antioxidant in the range of 0.3-1% by weight, and the carbon fiber material in the range of 3-15% by weight.

Furthermore, the phase solvent is maleic anhydride grafted ethylene methyl acrylate copolymer, the antioxidant is phenolic antioxidant 1010, and the toughening agent is ethylene methyl acrylate copolymer.

The present disclosure provides a method for manufacturing carbon fiber blended modified 3D printing consumables. The method comprises:
step 1: preparing raw materials required for manufacturing the carbon fiber blended modified 3D printing consumables and proportioning the raw materials required for manufacturing the carbon fiber blended modified 3D printing consumables according to a predetermined ratio of the raw materials;
step 2: putting proportioned raw materials required for manufacturing the carbon fiber blended modified 3D printing consumables into a high-speed mixer; mixing the proportioned raw materials required for manufacturing the carbon fiber blended modified 3D printing consumables at a high speed for ten to twenty minutes, by the high-speed mixer, to evenly mix the proportioned raw materials required for manufacturing the carbon fiber blended modified 3D printing consumables; and obtaining a mixture of the proportioned raw materials required for manufacturing the carbon fiber blended modified 3D printing consumables;
step 3: putting the mixture of the proportioned raw materials required for manufacturing the carbon fiber blended modified 3D printing consumables into a twin-screw modified granulator; putting a predetermined proportion of carbon fiber material into the twin-screw modified granulator through a side feeding mechanism; and processing the carbon fiber material with the mixture of the proportioned raw materials required for manufacturing the carbon fiber blended modified 3D printing consumables;
step 4: modifying the mixture of the proportioned raw materials required for manufacturing the carbon fiber blended modified 3D printing consumables and the carbon fiber material by the twin-screw modified granulator; and coupling and extruding modified materials by the twin-screw modified granulator to obtain a plastic wire blended with plastic and carbon fiber;
step 5: putting the plastic wire blended with plastic and carbon fiber into a water tank to cool; after cooling, cutting the plastic wire into pellets through a pelletizing device; and drying the pellets through a dryer after pelletizing;
step 6: putting dried pellets into a single-screw wire-drawing device; and
processing the dried pellets to obtain manufactured 3D printing consumables; and
step 7: cooling the manufactured 3D printing consumables through a cooling water tank, and rewinding the manufactured 3D printing consumables by a tractor and a winding device connected with the tractor.

Furthermore, the carbon fiber blended modified 3D printing consumables in step 1 is selected from a group consisting of carbon fiber polycarbonate 3D printing consumables, carbon fiber polylactic acid 3D printing consumables, carbon fiber copolyester 3D printing consumables, carbon fiber copolymer 3D printing consumables, carbon fiber nylon 3D printing consumables, and other carbon fiber plastic 3D printing consumables.

Furthermore, when manufacturing the carbon fiber polycarbonate 3D printing consumables, the raw materials to be proportioned according to the predetermined ratio comprise polycarbonate in a range of 20-60% by weight, copolyester in a range of 20-60% by weight, phase solvent in a range of 1-5% by weight, antioxidant in a range of by weight, and carbon fiber material in a range of 3-15% by weight for manufacturing the carbon fiber polycarbonate 3D printing consumables.

When manufacturing the carbon fiber polylactic acid 3D printing consumables, the raw materials to be proportioned according to the predetermined ratio comprise polylactic acid in a range of 40-80% by weight, toughening agent in a range of 5-15% by weight, the phase solvent in a range of 1-5% by weight, the antioxidant in a range of 0.3-1% by weight, and the carbon fiber material in the range of 3-15% by weight for manufacturing the carbon fiber polylactic acid 3D printing consumables.

When manufacturing the carbon fiber copolyester 3D printing consumables, the raw materials to be proportioned according to the predetermined ratio comprise the copolyester in a range of 40-80% by weight, the toughening agent in the range of 5-15% by weight, the phase solvent in the range of 1-5% by weight, the antioxidant in the range of 0.3-1% by weight, and the carbon fiber material in the range of 3-15% by weight for manufacturing the carbon fiber copolyester 3D printing consumables.

When manufacturing the carbon fiber nylon 3D printing consumables, the raw materials to be proportioned according to the predetermined ratio comprise nylon in a range of 40-80% by weight, toughening agent in a range of 5-15% by weight, phase solvent in a range of 1-5% by weight, antioxidant in a range of 0.3-1% by weight, and carbon fiber material in a range of 3-15% by weight for manufacturing the carbon fiber nylon 3D printing consumables.

When manufacturing the carbon fiber copolymer 3D printing consumables, the raw materials to be proportioned according to the predetermined ratio comprise specified proportions of copolymers, the phase solvent, and the antioxidant;

When manufacturing the other carbon fiber plastic 3D printing consumables, the raw materials to be proportioned according to the predetermined ratio comprise specified proportions of special plastics, the phase solvent, and the antioxidant.

Furthermore, in the step 3, when manufacturing the carbon fiber polycarbonate 3D printing consumables, a weight ratio of the carbon fiber material to be added is 3-15% of a weight of the raw materials to be proportioned according to the predetermined ratio.

Furthermore, in the step 3, when manufacturing the carbon fiber polylactic acid 3D printing consumables, the carbon fiber material is added in a range of 3-15% by weight. The weight ratio of the carbon fiber material is adapted to a weight ratio of the raw materials to be proportioned according to the predetermined ratio.

Furthermore, in the step 3, when manufacturing the carbon fiber copolyester 3D printing consumables, the carbon fiber material is added in a range of 3-15% by weight. The weight ratio of the carbon fiber material is adapted to the weight ratio of the raw materials to be proportioned according to the predetermined ratio.

Furthermore, in the step 3, when manufacturing the carbon fiber nylon 3D printing consumables, the carbon fiber material is added in a range of 3-15% by weight. The weight ratio of the carbon fiber material is adapted to the weight ratio of the raw materials to be proportioned according to the predetermined ratio.

Furthermore, wherein in the step 3, when manufacturing the carbon fiber copolymer 3D printing consumables, the carbon fiber material is added in a range of 3-15% by weight. The weight ratio of the carbon fiber material is adapted to the weight ratio of the raw materials to be proportioned according to the predetermined ratio.

In the step 3, when manufacturing the other carbon fiber plastic 3D printing consumables, the carbon fiber material is added in a range of 3-15% by weight; the weight ratio of the carbon fiber material is adapted to the weight ratio of the raw materials to be proportioned according to the predetermined ratio.

The present disclosure provides high-performance fused deposition modeling (FDM) type 3D printing consumables with high mechanical strength for 3D printing. Through blending modification, the 3D printing consumables meet needs of 3D printing in terms of reducing a shrinkage rate of the 3D printing consumables and improving the layer adhesion. Meanwhile, since chopped carbon fibers are compounded, rigidity of the 3D printing consumables is improved, the shrinkage rate of the 3D printing consumables is further reduced, and a specific gravity of the 3D printing consumables is reduced. Further, a printed surface of a printed piece has a fiber texture, which is tightly combined layer by layer, so an impact strength of the printed piece reaches more than twelve (KJ/M³), which obviously reaches a strength of ordinary plastic pieces. The printed piece meets mechanical strength conditions of most common applications, thus avoiding problems that conventional 3D printing consumables are mainly PLA and ABS, and few conventional high-performance engineering plastics can be used in 3D printing, and avoiding problems that PLA and other materials currently widely used in 3D printing have poor physical properties and cannot be used in applications requiring high mechanical strength, and ordinary modified engineering plastics are not suitable for direct production of 3D printing consumables. The carbon fiber blended modified 3D printing consumables produced by the present disclosure has excellent comprehensive properties, and is high-performance consumables used in FDM 3D printing, which improves practicability and stability.

### BRIEF DESCRIPTION OF DRAWINGS

FIG. 1 is a flow chart of a method for manufacturing carbon fiber blended modified 3D printing consumables of the present disclosure.

FIG. 2 is a flow chart of a method for manufacturing carbon fiber polycarbonate 3D printing consumables of the present disclosure.

FIG. 3 is a flow chart of a method for manufacturing carbon fiber polylactic acid 3D printing consumables of the present disclosure.

FIG. 4 is a flow chart of a method for manufacturing carbon fiber copolyester 3D printing consumables of the present disclosure.

FIG. 5 is a flow chart of a method for manufacturing carbon fiber copolymer 3D printing consumables of the present disclosure.

FIG. 6 is a flow chart of a method for manufacturing carbon fiber nylon 3D printing consumables of the present disclosure.

FIG. 7 is a flow chart of a method for manufacturing other carbon fiber plastic 3D printing consumables of the present disclosure.

### DETAILED DESCRIPTION

In order to deepen an understanding of the present disclosure, the present disclosure will be described in further detail below with reference to the embodiments. The embodiments are only used to explain the present disclosure and do not constitute a limitation on the protection scope of the present disclosure.

In order to realize the purpose of the present disclosure, the present disclosure is embodied through the following technical solutions.

### Embodiment 1

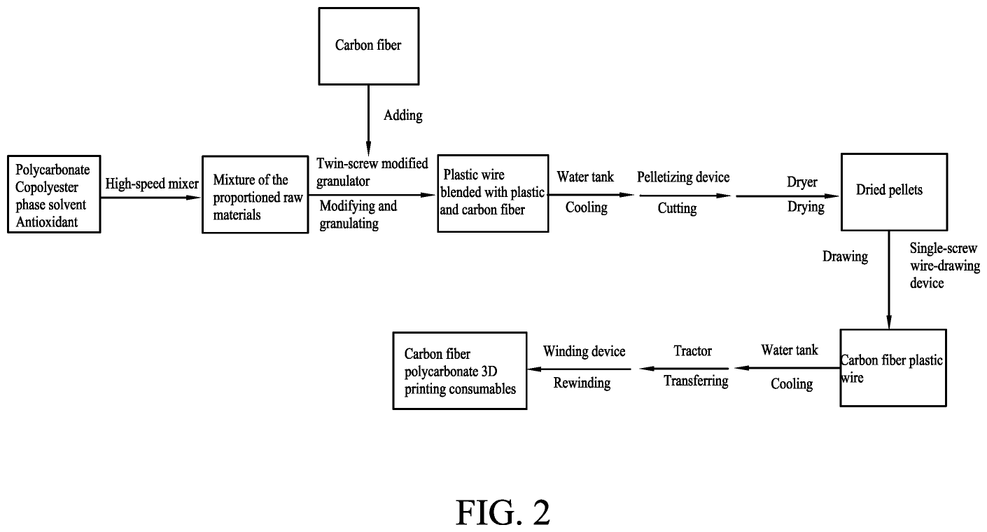

As shown in FIG. 2, the present disclosure provides carbon fiber blended modified 3D printing consumables. The carbon fiber blended modified 3D printing consumables comprise one of carbon fiber polycarbonate 3D printing consumables, carbon fiber polylactic acid 3D printing consumables, carbon fiber copolyester 3D printing consumables, carbon fiber copolymer 3D printing consumables, carbon fiber nylon 3D printing consumables, and other carbon fiber plastic 3D printing consumables.

The carbon fiber polycarbonate 3D printing consumables comprise polycarbonate in a range of 20-60% by weight, copolyester in a range of 20-60% by weight, phase solvent in a range of 1-5% by weight, antioxidant in a range of 0.3-1% by weight, and carbon fiber material in a range of 3-15% by weight.

The phase solvent is maleic anhydride grafted ethylene methyl acrylate copolymer, the antioxidant is phenolic antioxidant 1010.

### Embodiment 2

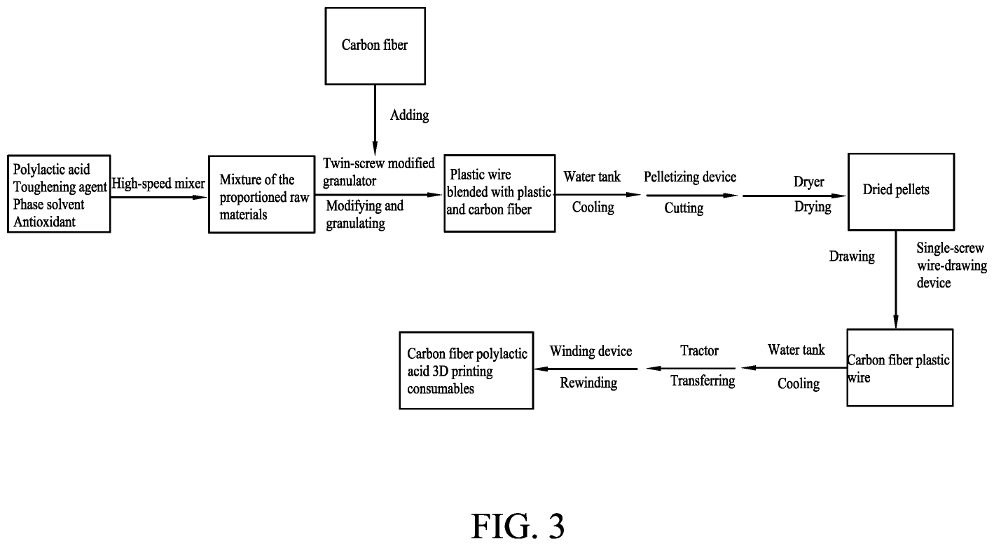

As shown in FIG. 3, the present disclosure provides carbon fiber blended modified 3D printing consumables. The carbon fiber blended modified 3D printing consumables comprise one of carbon fiber polycarbonate 3D printing consumables, carbon fiber polylactic acid 3D printing consumables, carbon fiber copolyester 3D printing consumables, carbon fiber copolymer 3D printing consumables, carbon fiber nylon 3D printing consumables, and other carbon fiber plastic 3D printing consumables.

The carbon fiber polylactic acid 3D printing consumables comprise polylactic acid in a range of 40-80% by weight, toughening agent in a range of 5-15% by weight, the phase solvent in a range of 1-5% by weight, the antioxidant in a range of 0.3-1% by weight, and the carbon fiber material in a range of 3-15% by weight.

The phase solvent is maleic anhydride grafted ethylene methyl acrylate copolymer, the antioxidant is phenolic antioxidant 1010, and the toughening agent is ethylene methyl acrylate copolymer.

### Embodiment 3

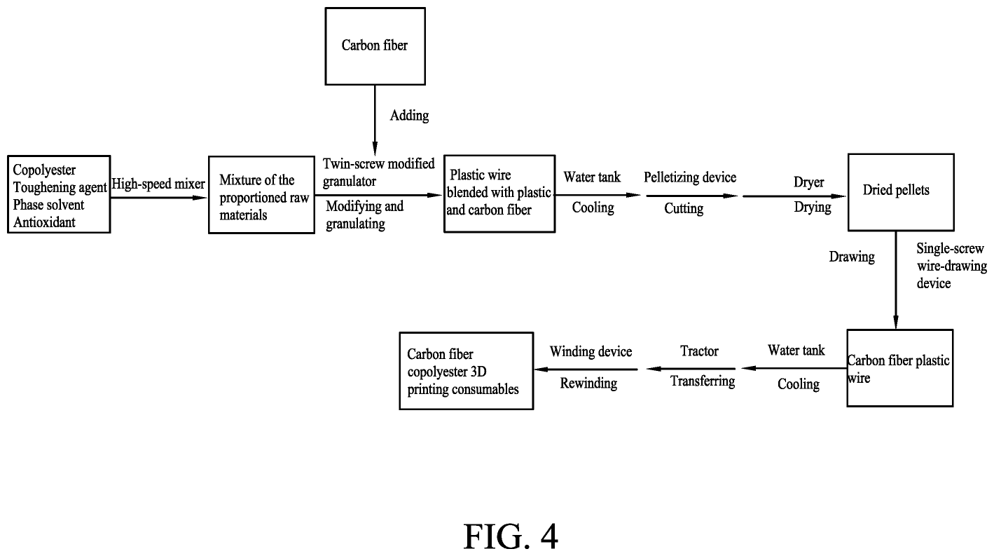

As shown in FIG. 4, the present disclosure provides carbon fiber blended modified 3D printing consumables. The carbon fiber blended modified 3D printing consumables comprise one of carbon fiber polycarbonate 3D printing consumables, carbon fiber polylactic acid 3D printing consumables, carbon fiber copolyester 3D printing consumables, carbon fiber copolymer 3D printing consumables, carbon fiber nylon 3D printing consumables, and other carbon fiber plastic 3D printing consumables.

The carbon fiber copolyester 3D printing consumables comprise the copolyester in a range of 40-80% by weight, the toughening agent in the range of 5-15% by weight, the phase solvent in the range of 1-5% by weight, the antioxidant in the range of 0.3-1% by weight, and the carbon fiber material in the range of 3-15% by weight.

The phase solvent is maleic anhydride grafted ethylene methyl acrylate copolymer, the antioxidant is phenolic antioxidant 1010, and the toughening agent is ethylene methyl acrylate copolymer.

### Embodiment 4

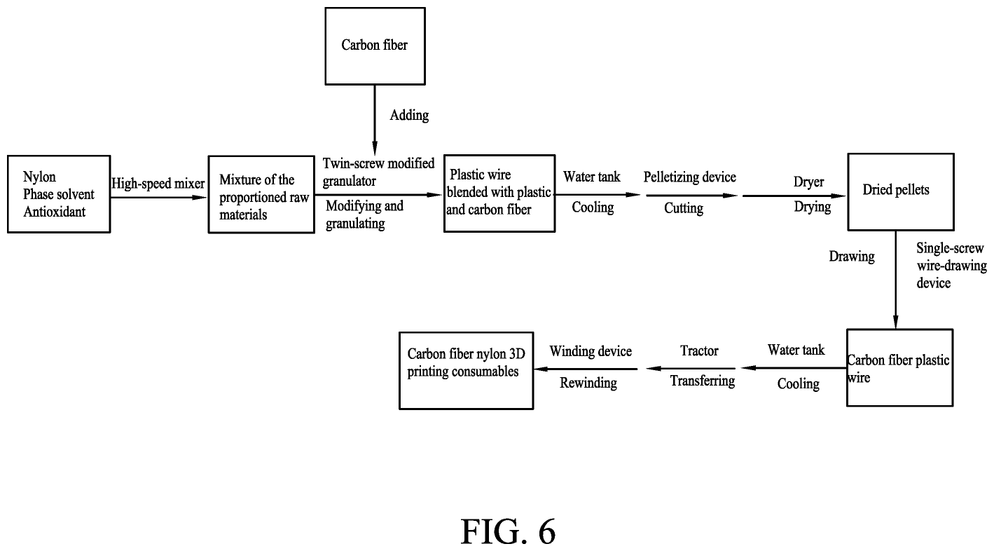

As shown in FIG. 6, the present disclosure provides carbon fiber blended modified 3D printing consumables. The carbon fiber blended modified 3D printing consumables comprise one of carbon fiber polycarbonate 3D printing consumables, carbon fiber polylactic acid 3D printing consumables, carbon fiber copolyester 3D printing consumables, carbon fiber copolymer 3D printing consumables, carbon fiber nylon 3D printing consumables, and other carbon fiber plastic 3D printing consumables.

The carbon fiber nylon 3D printing consumables comprise nylon in a range of 40-80% by weight, the toughening agent in the range of 5-15% by weight, the phase solvent in the range of 1-5% by weight, the antioxidant in the range of 0.3-1% by weight, and the carbon fiber material in the range of 3-15% by weight.

The phase solvent is maleic anhydride grafted ethylene methyl acrylate copolymer, the antioxidant is phenolic antioxidant 1010, and the toughening agent is ethylene methyl acrylate copolymer.

### Embodiment 5

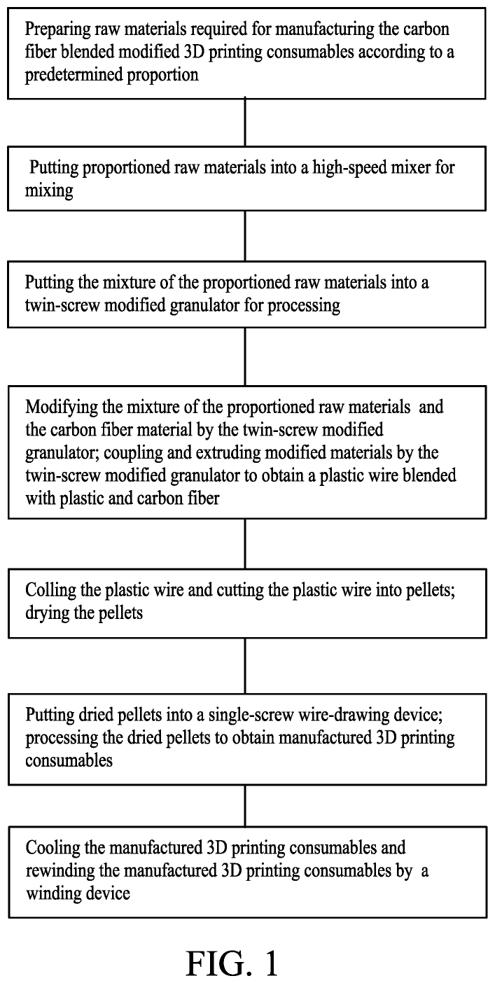

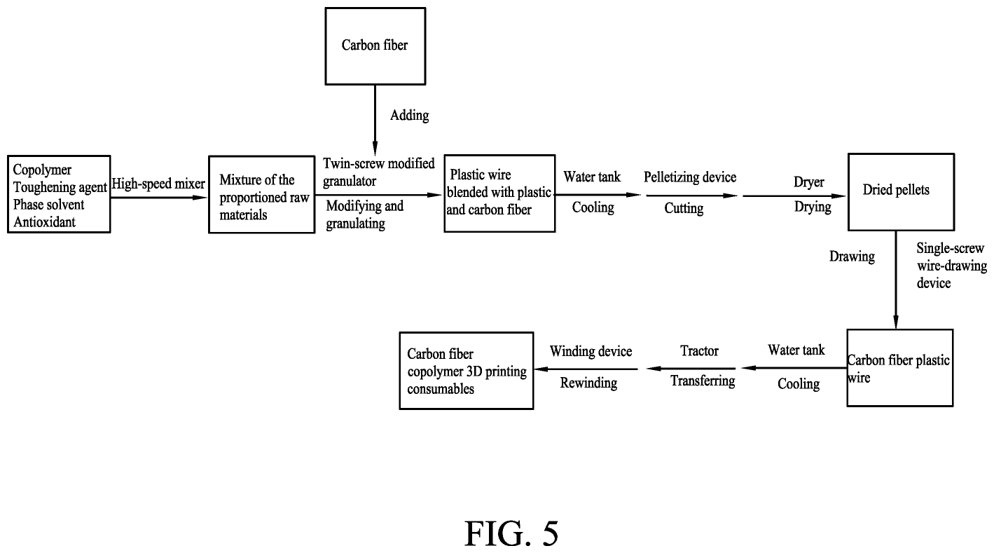

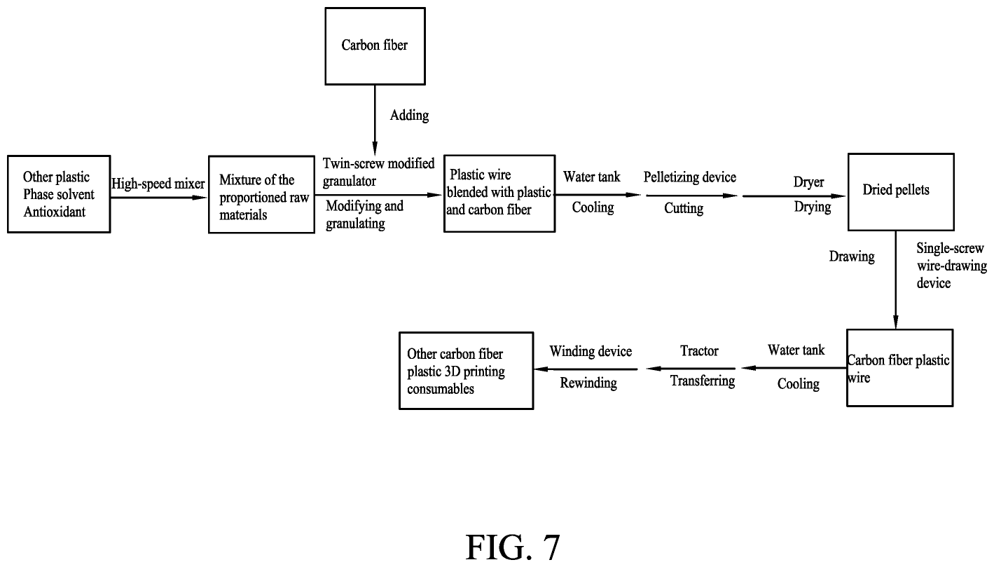

As shown in FIGS. 1-7, the embodiment provides a method for manufacturing carbon fiber blended modified 3D printing consumables. The method for manufacturing carbon fiber blended modified 3D printing consumables comprises steps:

step 1: preparing raw materials required for manufacturing the carbon fiber blended modified 3D printing consumables and proportioning the raw materials required for manufacturing the carbon fiber blended modified 3D printing consumables according to a predetermined ratio of the raw materials;

step 2: putting proportioned raw materials required for manufacturing the carbon fiber blended modified 3D printing consumables into a high-speed mixer; mixing the proportioned raw materials required for manufacturing the carbon fiber blended modified 3D printing consumables at a high speed for ten to twenty minutes, by the high-speed mixer, to evenly mix the proportioned raw materials required for manufacturing the carbon fiber blended modified 3D printing consumables; and obtaining a mixture of the proportioned raw materials required for manufacturing the carbon fiber blended modified 3D printing consumables;

step 3: putting the mixture of the proportioned raw materials required for manufacturing the carbon fiber blended modified 3D printing consumables into a twin-screw modified granulator; putting a predetermined proportion of carbon fiber material into the twin-screw modified granulator through a side feeding mechanism; and processing the carbon fiber material with the mixture of the proportioned raw materials required for manufacturing the carbon fiber blended modified 3D printing consumables;

step 4: modifying the mixture of the proportioned raw materials required for manufacturing the carbon fiber blended modified 3D printing consumables and the carbon fiber material by the twin-screw modified granulator; and coupling and extruding modified materials by the twin-screw modified granulator to obtain a plastic wire blended with plastic and carbon fiber;

step 5: putting the plastic wire blended with plastic and carbon fiber into a water tank to cool; after cooling, cutting the plastic wire into pellets through a pelletizing device; and drying the pellets through a dryer after pelletizing;

step 6: putting dried pellets into a single-screw wire-drawing device; and processing the dried pellets to obtain manufactured 3D printing consumables; and

step 7: cooling the manufactured 3D printing consumables through a cooling water tank, and rewinding the manufactured 3D printing consumables by a tractor and a winding device connected with the tractor.

The carbon fiber blended modified 3D printing consumables in the step 1 is selected from a group consisting of carbon fiber polycarbonate 3D printing consumables, carbon fiber polylactic acid 3D printing consumables, carbon fiber copolyester 3D printing consumables, carbon fiber copolymer 3D printing consumables, carbon fiber nylon 3D printing consumables, and other carbon fiber plastic 3D printing consumables.

When manufacturing the carbon fiber polycarbonate 3D printing consumables, the raw materials to be proportioned according to the predetermined ratio comprise polycarbonate in a range of 20-60% by weight, copolyester in a range of 20-60% by weight, phase solvent in a range of 1-5% by weight, antioxidant in a range of 0.3-1% by weight, and carbon fiber material in a range of 3-15% by weight for manufacturing the carbon fiber polycarbonate 3D printing consumables.

When manufacturing the carbon fiber polylactic acid 3D printing consumables, the raw materials to be proportioned according to the predetermined ratio comprise nylon in a range of 40-80% by weight, toughening agent in a range of 5-15% by weight, phase solvent in a range of 1-5% by weight, antioxidant in a range of 0.3-1% by weight, and carbon fiber material in a range of 3-15% by weight for manufacturing the carbon fiber polylactic acid 3D printing consumables.

When manufacturing the carbon fiber copolyester 3D printing consumables, the raw materials to be proportioned according to the predetermined ratio comprise the copolyester in a range of 40-80% by weight, the toughening agent in the range of 5-15% by weight, the phase solvent in the range of 1-5% by weight, the antioxidant in the range of 0.3-1% by weight, and the carbon fiber material in the range of 3-15% by weight for manufacturing the carbon fiber copolyester 3D printing consumables.

When manufacturing the carbon fiber nylon 3D printing consumables, the raw materials to be proportioned according to the predetermined ratio comprise nylon in a range of 40-80% by weight, toughening agent in a range of 5-15% by weight, phase solvent in a range of 1-5% by weight, antioxidant in a range of 0.3-1% by weight, and carbon fiber material in a range of 3-15% by weight for manufacturing the carbon fiber nylon 3D printing consumables.

When manufacturing the carbon fiber copolymer 3D printing consumables, the raw materials to be proportioned according to the predetermined ratio comprise specified proportions of copolymers, the phase solvent, and the antioxidant;

When manufacturing the other carbon fiber plastic 3D printing consumables, the raw materials to be proportioned according to the predetermined ratio comprise specified proportions of special plastics, the phase solvent, and the antioxidant.

In the step 3, when manufacturing the carbon fiber polycarbonate 3D printing consumables, the carbon fiber material is added in a range of 3-15% by weight. A weight ratio of the carbon fiber material is adapted to a weight ratio of the raw materials to be proportioned according to the predetermined ratio.

In the step 3, when manufacturing the carbon fiber polylactic acid 3D printing consumables, the carbon fiber material is added in the range of 3-15% by weight. A weight ratio of the carbon fiber material is adapted to a weight ratio of the raw materials to be proportioned according to the predetermined ratio.

In the step 3, when manufacturing the carbon fiber copolyester 3D printing consumables, the carbon fiber material is added in a range of 3-15% by weight. A weight ratio of the carbon fiber material is adapted to a weight ratio of the raw materials to be proportioned according to the predetermined ratio.

In the step 3, when manufacturing the carbon fiber nylon 3D printing consumables, the carbon fiber material is added in a range of 3-15% by weight. A weight ratio of the carbon fiber material is adapted to a weight ratio of the raw materials to be proportioned according to the predetermined ratio.

In the step 3, when manufacturing the carbon fiber copolymer 3D printing consumables, the carbon fiber material is added in a range of 3-15% by weight. A weight ratio of the carbon fiber material is suitable for a weight ratio of the raw materials to be proportioned according to the predetermined ratio.

In the step 3, when manufacturing the other carbon fiber plastic 3D printing consumables, the carbon fiber material is added in a range of 3-15% by weight. A weight ratio of the carbon fiber material is suitable for a weight ratio of the raw materials to be proportioned according to the predetermined ratio.

In an actual application, when manufacturing specific carbon fiber blended modified 3D printing consumables, raw materials required for manufacturing the specific 3D printing consumables are prepared and the raw materials required for manufacturing the specific 3D printing consumables are proportioned according to the predetermined ratio of the raw materials. Then the proportioned raw materials required for manufacturing the specific 3D printing consumables are put into the high-speed mixer, and the proportioned raw materials required for manufacturing the specific 3D printing consumables are mixed at a high speed for ten to twenty minutes by the high-speed mixer to evenly mix the proportioned raw materials required for manufacturing the specific 3D printing consumables. Then the mixture of the proportioned raw materials required for manufacturing the specific 3D printing consumables is obtained. After that, the mixture of the proportioned raw materials required for manufacturing the specific 3D printing consumables is put into the twin-screw modified granulator and a predetermined proportion of specific carbon fiber material is put into the twin-screw modified granulator through the side feeding mechanism. The specific carbon fiber material with the mixture of the proportioned raw materials required for manufacturing the specific 3D printing consumables is processed and the mixture of the proportioned raw materials required for manufacturing the specific 3D printing consumables and the specific carbon fiber material is modified and processed by the twin-screw modified granulator. The modified mixture is coupled and extruded by the twin-screw modified granulator to obtain a plastic wire blended with plastic and carbon fiber. Subsequently, the plastic wire blended with plastic and carbon fiber is put into the water tank to cool. After cooling, the plastic wire blended with plastic and carbon fiber is cut into pellets through the pelletizing device and the pellets are dried through the dryer after pelletizing. The dried pellets are put into the single-screw wire-drawing device to obtain manufactured 3D printing consumables. Finally, the manufactured 3D printing consumables are cooled through the cooling water tank, and the manufactured 3D printing consumables are rewound by the tractor and the winding device connected with the tractor.

Through blending modification, the 3D printing consumables meet needs of 3D printing in terms of reducing a shrinkage rate of the 3D printing consumables and improving the layer adhesion. Meanwhile, since chopped carbon fibers are compounded, rigidity of the 3D printing consumables is improved, the shrinkage rate of the 3D printing consumables is further reduced, and a specific gravity of the 3D printing consumables is reduced. Further, a printed surface of a printed piece has a fiber texture, which is tightly combined layer by layer, so an impact strength of the printed piece reaches more than twelve (KJ/M 3), which obviously reaches a strength of ordinary plastic pieces. The printed piece meets mechanical strength conditions of most common applications. Thus, the method for manufacturing the carbon fiber blended modified 3D printing consumables is completed.

The foregoing descriptions have shown and described basic principles, main features, and advantages of the present disclosure. Those skilled in the art should understand that the present disclosure is not limited by the above-mentioned embodiments. The above-mentioned embodiments and descriptions only illustrate the principle of the present disclosure. Without departing from the spirit and scope of the present disclosure, the present disclosure also has various changes and modifications, which should all fall within the protected scope of the present disclosure. The protected scope of the present disclosure is defined by the appended claims and their equivalents.

What is claimed is:

1. Carbon fiber blended modified 3D printing consumables, comprising: one of carbon fiber polycarbonate 3D printing consumables, carbon fiber polylactic acid 3D printing consumables, carbon fiber copolyester 3D printing consumables, carbon fiber copolymer 3D printing consumables, carbon fiber nylon 3D printing consumables, and other carbon fiber plastic 3D printing consumables;
wherein the carbon fiber polycarbonate 3D printing consumables comprise polycarbonate in a range of 20-60% by weight, copolyester in a range of 20-60% by weight, phase solvent in a range of 1-5% by weight, antioxidant in a range of 0.3-1% by weight, and carbon fiber material in a range of 3-15% by weight;
wherein the carbon fiber polylactic acid 3D printing consumables comprise polylactic acid in a range of 40-0% by weight, toughening agent in a range of 5-15% by weight, the phase solvent in a range of 1-5% by weight, the antioxidant in a range of 0.3-1% by weight, and the carbon fiber material in a range of 3-15% by weight;
wherein the carbon fiber copolyester 3D printing consumables comprise the copolyester in a range of 40-80% by weight, the toughening agent in the range of 5-15% by weight, the phase solvent in the range of 1-5% by weight, the antioxidant in the range of 0.3-1% by weight, and the carbon fiber material in the range of 3-15% by weight; and
wherein the carbon fiber nylon 3D printing consumables comprise nylon in a range of 40-80% by weight, the toughening agent in the range of 5-15% by weight, the phase solvent in the range of 1-5% by weight, the antioxidant in the range of 0.3-1% by weight, and the carbon fiber material in the range of 3-15% by weight.

2. The carbon fiber blended modified 3D printing consumables according to claim 1, wherein the phase solvent is maleic anhydride grafted ethylene methyl acrylate copolymer, the antioxidant is phenolic antioxidant 1010, and the toughening agent is ethylene methyl acrylate copolymer.

3. A method for manufacturing carbon fiber blended modified 3D printing consumables, comprising steps:
step 1: preparing raw materials comprising a plastic required for manufacturing the carbon fiber blended modified 3D printing consumables and proportioning the raw materials required for manufacturing the carbon fiber blended modified 3D printing consumables according to a predetermined ratio of the raw materials;
step 2: putting proportioned raw materials required for manufacturing the carbon fiber blended modified 3D printing consumables into a high-speed mixer; mixing the proportioned raw materials required for manufacturing the carbon fiber blended modified 3D printing consumables at a high speed for ten to twenty minutes, by the high-speed mixer, to evenly mix the proportioned raw materials required for manufacturing the carbon fiber blended modified 3D printing consumables; and obtaining a mixture of the proportioned raw materials required for manufacturing the carbon fiber blended modified 3D printing consumables;
step 3: putting the mixture of the proportioned raw materials required for manufacturing the carbon fiber blended modified 3D printing consumables into a twin-screw modified granulator;
putting a predetermined proportion of carbon fiber material into the twin-screw modified granulator through a side feeding mechanism; and processing the carbon fiber material with the mixture of the proportioned raw materials required for manufacturing the carbon fiber blended modified 3D printing consumables;
step 4: modifying the mixture of the proportioned raw materials required for manufacturing the carbon fiber blended modified 3D printing consumables and the carbon fiber material by the twin-screw modified granulator; and coupling and extruding modified materials by the twin-screw modified granulator to obtain a plastic wire blended with plastic and carbon fiber;
step 5: putting the plastic wire blended with plastic and carbon fiber into a water tank to cool; after cooling, cutting the plastic wire into pellets through a pelletizing device; and drying the pellets through a dryer after pelletizing;
step 6: putting dried pellets into a single-screw wire-drawing device; and processing the dried pellets to obtain manufactured 3D printing consumables; and
step 7: cooling the manufactured 3D printing consumables through a cooling water tank, and rewinding the manufactured 3D printing consumables by a tractor and a winding device connected with the tractor;
wherein the carbon fiber blended modified 3D printing consumables in the step 1 is selected from a group consisting of carbon fiber polycarbonate 3D printing consumables, carbon fiber polylactic acid 3D printing consumables, carbon fiber copolyester 3D printing consumables, carbon fiber copolymer 3D printing consumables, carbon fiber nylon 3D printing consumables, and other carbon fiber plastic 3D printing consumables;
wherein when manufacturing the carbon fiber polycarbonate 3D printing consumables, the raw materials to be proportioned according to the predetermined ratio comprise polycarbonate in a range of 20-60% by weight, copolyester in a range of 20-60% by weight, phase solvent in a range of 1-5% by weight, antioxidant in a range of 0.3-1% by weight, and carbon fiber material in a range of 3-5% by weight for manufacturing the carbon fiber polycarbonate 3D printing consumables;
wherein when manufacturing the carbon fiber polylactic acid 3D printing consumables, the raw materials to be proportioned according to the predetermined ratio comprise polylactic acid in a range of 40-80% by weight, toughening agent in a range of 5-15% by weight, the phase solvent in a range of 1-5% by weight, the antioxidant in a range of 0.3-1% by weight, and the carbon fiber material in the range of 3-5% by weight for manufacturing the carbon fiber polylactic acid 3D printing consumables; and
wherein when manufacturing the carbon fiber copolyester 3D printing consumables, the raw materials to be proportioned according to the predetermined ratio comprise the copolyester in a range of 40-80% by weight, the toughening agent in the range of 5-15% by weight, the phase solvent in the range of 1-5% by weight, the antioxidant in the range of 0.3-1% by weight, and the carbon fiber material in the range of 3-5% by weight for manufacturing the carbon fiber copolyester 3D printing consumables.

4. (canceled)

5. (canceled)

6. The method for manufacturing carbon fiber blended modified 3D printing consumables according to claim 3, wherein when manufacturing the carbon fiber nylon 3D printing consumables, the raw materials to be proportioned according to the predetermined ratio comprise nylon in a range of 40-80% by weight, toughening agent in a range of 5-15% by weight, phase solvent in a range of 1-5% by weight, antioxidant in a range of 0.3-1% by weight, and carbon fiber material in a range of 3-5% by weight for manufacturing the carbon fiber nylon 3D printing consumables;
wherein when manufacturing the carbon fiber copolymer 3D printing consumables, the raw materials to be proportioned according to the predetermined ratio comprise specified proportions of copolymers, the phase solvent, and the antioxidant; and
wherein when manufacturing the other carbon fiber plastic 3D printing consumables, the raw materials to be proportioned according to the predetermined ratio comprise specified proportions of special exclusive plastics, the phase solvent, and the antioxidant.

7. The method for manufacturing carbon fiber blended modified 3D printing consumables according to claim 3, wherein in the step 3, when manufacturing the carbon fiber polycarbonate 3D printing consumables, the carbon fiber material is added in a range of 3-5% by weight; a weight ratio of the carbon fiber material is adapted to a weight ratio of the raw materials to be proportioned according to the predetermined ratio.

8. The method for manufacturing carbon fiber blended modified 3D printing consumables according to claim 3, wherein in the step 3, when manufacturing the carbon fiber polylactic acid 3D printing consumables, the carbon fiber material is added in a range of 3-5% by weight; a weight ratio of the carbon fiber material is adapted to a weight ratio of the raw materials to be proportioned according to the predetermined ratio.

9. The method for manufacturing carbon fiber blended modified 3D printing consumables according to claim 3, wherein in the step 3, when manufacturing the carbon fiber copolyester 3D printing consumables, the carbon fiber material is added in a range of 3-5% by weight; a weight ratio of the carbon fiber material is adapted to a weight ratio of the raw materials to be proportioned according to the predetermined ratio.

10. The method for manufacturing carbon fiber blended modified 3D printing consumables according to claim 3, wherein in the step 3, when manufacturing carbon fiber nylon 3D printing consumables, the carbon fiber material is added in a range of 3-5% by weight; a weight ratio of the carbon fiber material is adapted to a weight ratio of the raw materials to be proportioned according to the predetermined ratio comprise.

11. The method for manufacturing carbon fiber blended modified 3D printing consumables according to claim 3, wherein in the step 3, when manufacturing the carbon fiber copolymer 3D printing consumables, the carbon fiber material is added in a range of 3-5% by weight; a weight ratio of the carbon fiber material is adapted to a weight ratio of the raw materials to be proportioned according to the predetermined ratio; and
wherein in the step 3, when manufacturing the other carbon fiber plastic 3D printing consumables, a weight ratio of the carbon fiber material is adapted to a weight ratio of the raw materials to be proportioned according to the predetermined ratio.
